(19) United States
(12) Patent Application Publication
(10) Pub. No.: US 2015/0260087 A1
(43) Pub. Date: Sep. 17, 2015

(54) PISTON ENGINE AND AN ENGINE DEVICE COMPRISING THE SAME

(71) Applicant: Three Gemstar Automotive Technology (Shanghai) Co., Ltd., Shanghai (CN)

(72) Inventor: Wenge WANG, Shanghai (CN)

(21) Appl. No.: 14/464,665

(22) Filed: Aug. 20, 2014

(30) Foreign Application Priority Data
Mar. 13, 2014 (CN) 201410091788.1
Mar. 13, 2014 (CN) 201410091834.8

(51) Int. Cl. F02B 53/02; F02B 53/10

(52) U.S. Cl. CPC F02B 53/02; F02B 53/10

(57) ABSTRACT

The disclosure relates to a rotary piston, a piston engine comprising the rotary piston, and an engine device comprising the piston engine. The rotary piston comprises a piston body having a triangular vertical cross-section, mutually engaged large and small planetary gears fixed at the middle of the piston body, and a crankshaft running through the small planetary gear. The three angles of the triangular cross-section extend outwards to form protruded ends. The two sides of each protruded end form a compression groove and a combustion groove, respectively. The piston engine of the present disclosure comprises a shell, a crankshaft in the shell and two sets of rotary pistons, wherein the crankshaft has two ends and the two sets of rotary pistons are positioned symmetrically at the two ends of the crankshaft and separated by a holder positioned between the two sets of pistons.

### CROSS REFERENCE TO RELATED APPLICATION

This application is a U.S. national application under 35 U.S.C. §111(a) claiming priority, under 35 U.S.C. §119, to Chinese Patent Applications Nos. 201410091834.8 and 201410091788.1, both filed on Mar. 13, 2014, the contents of both of which are incorporated by reference herein in their entirety for all purposes.

### TECHNICAL FIELD

The present disclosure relates to engine technology, in particular to a rotary piston, a rotary piston engine comprising the rotary piston, and an engine device comprising the rotary piston engine.

### BACKGROUND

Fuel engines of the current technology include reciprocating engines and rotary engines. With a development history of more than a hundred years, the reciprocating engines have the advantages of mature technology, safety and reliability, and disadvantages of low efficiency, a conversion rate of less than 50%, loud noise, high carbon emission and serious pollution. Rotary engines have the advantages of small sizes, material saving, reduced weight and high conversion rate (one time higher). A two-cylinder rotary engine has stability and power equivalent to those of a six-cylinder four-stroke reciprocating engine; however, rotary engines also have disadvantages such as excessive emission, non-conformity, high temperature, loud noise and high fuel consumption. Automobiles of either type of engines are disadvantageous in aspects of loud noise and high fuel consumption.

In 2013, haze struck 25 provinces and over 100 large and medium-sized cities in China; the national average number of days struck by haze reached 29.9 days, creating a new record in the past 52 years. Particularly after entry into the winter, appearances of haze in alternating areas throughout the country attracted great attention; treatment of haze became an urgent problem to be solved in provinces and cities in China. The International Agency for Research on Cancer (IARC) identified air pollution as a carcinogen in a meeting held in Lyon, which was also publicly recognized by experts. Particularly, airborne particles, i.e. the so-called PM2.5, have been confirmed as a carcinogen to human beings. Automobile exhaust is a major source of PM 2.5.

Piston is the heart of an engine, and piston quality directly impacts on performance of a complete engine. At present, the most advanced rotary engine in the world is the Mazda rotary engine from Japan whose external surface generally has not been specially treated; it is praised by professionals as the best double-rotor engine in the world, featuring a small size, compacted structure, reduced weight, stronger power, and it represents a glory of the automobile industry. However, the engine fails to meet the Euro VI Standard in that it has technical defects, such as high temperature, loud noise and a broad friction area between the piston surface and the cylinder wall during operation, possible piston wear or even piston seizure after long-time working, which affects the working performance of the engine and increases fuel consumption and exhaust emission. Piston in the engine has become a technical bottleneck for Mazda. On Jun. 22, 2012, production of the piston device for the engine stopped in the Mazda factory in Hiroshima Japan, marking the end of the “automobile rotor age” led by the RX Series.

### SUMMARY OF THE DISCLOSURE

Some of the technical problems to be solved by embodiments of the present disclosure include loud noise and high fuel consumption in connection with the operation of fuel engines, a broad friction area between the piston surface and the cylinder wall during operation, and possible piston wear or even piston seizure after long-time working. To solve these technical problems, the present disclosure provides a rotary piston, a piston engine comprising the rotary piston, and an engine device comprising the piston engine.

According to some embodiments, a rotary piston comprises a piston body having a triangular vertical cross-section, mutually engaged large and small planetary gears fixed at the middle of the piston body, and a crankshaft running through the small planetary gear, wherein the three angles of the triangular vertical cross-section extend outwards to form protruded ends with a 120-degree angle between adjacent protruded ends, and the two sides of each protruded end form a compression groove and a combustion groove, respectively.

According to some embodiments, the rotary piston can be designed in the shape of a fish head to increase fuel filling capacity between a cylinder and the piston body, so that under the effect of directed explosive mechanics, explosion thrust can move along the head end to drive the rotation and realize full combustion in a chamber via multiple rotations, thereby reducing CO₂ emission. According to some embodiments, the rotary piston is driven by the crankshaft that drives the small and the large planetary gears. Under air suction conditions, the rotary piston's power consumption can be reduced by ½ to save labor. Under compression working conditions, the rotary piston's power consumption can be increased by ⅓ and reach the maximum density and the smallest volume of the compressed air. Upon ignition and outburst, the large and the small planetary gears can be on a 180-degree horizontal line, and when the small planetary gear moves a distance, with the same mechanical boosting lever, the rotary piston can do twice the work, the output torque increases, and the delivered horsepower of the engine can be promoted, realizing the goals of high efficiency, energy saving and environment-friendliness.

According to some embodiments, the combustion grooves are deeper than the compression grooves. This can result in the enlargement of the fuel filling capacity between the cylinder and the piston body so that fuel can burn sufficiently during rotation, and emission of CO₂ can be reduced.

According to some embodiments, a protruded end comprises a sealing ring embedded in the middle of the surface of the protruded end. According to these embodiments, the sealing ring mainly functions to seal the empty chamber between the rotary piston and the inner wall of the cylinder, so as to prevent air leakage upon friction work and prolong the service life. Additionally, the sealing ring can also apply lubricant supplied by an oil pump to the inner wall of the cylinder evenly on the inner wall, so that friction between the cylinder wall and the rotary piston can be reduced and lubrication can be achieved. With effective reduction of the friction factor between the piston and the cylinder wall, working performance of the engine can be promoted, fuel consumption can be reduced, and the service life of the piston can be prolonged.

According to some preferred embodiments, a protruded end comprises an arc surface. According to these embodiments, the arc surface can closely contact the inner wall of the cylinder and reduce friction during rotation. If a protruded end has any edge, such edge may cause crash between the rotary piston and the cylinder wall during rotation, resulting in damage to the rotary piston. Therefore, an arc surface design can provide strong utility.

The present disclosure also discloses an engine applying the rotary piston described above and comprising the rotary piston and a cylinder, an air inlet and an air outlet on one side of the cylinder, a spark plug fixed on the other side of the cylinder, wherein the rotary piston is placed inside the cylinder, and fuel is fillable in an empty chamber between the rotary piston and the inner wall of the cylinder.

The engine using the rotary piston provided in the present disclosure has the advantages of simple yet unreduced structure, strong utility, fewer parts and simple technological procedures. It can also save labor and resources, while reducing pollution to the production environment. Meanwhile, it can also provide a solution to such technical defects in existing technology as high temperature, loud noise, a broad friction area between the piston surface and the cylinder wall during operation, possible piston wear or even piston seizure after long-time working, which affects the working performance of the engine, and increases fuel consumption and exhaust emission. According to some embodiments, the rotary piston is driven by the crankshaft that drives the small and the large planetary gears. According to these embodiments, under air suction conditions, the rotary piston power consumption is reduced by ½ to save labor. Under compression working conditions, the rotary piston power consumption is increased by ⅓ and reaches the maximum density and the smallest volume of the compressed air. Upon ignition and outburst, the large and the small planetary gears can be on a 180-degree horizontal line, and when the small planetary gear moves a distance, with the same mechanical boosting lever, the rotary piston can do twice the work, the output torque increases, and the delivered horsepower of the engine can be promoted, realizing the goals of high efficiency, energy saving and environment-friendliness.

According to some embodiments, clearances are left between the surface of the protruded ends and the inner wall of the cylinder, with sealing rings contacting the inner wall of the cylinder. According to these embodiments, the sealing rings function to seal the empty chamber between the rotary piston and the inner wall of the cylinder, so as to prevent air leakage upon friction work and prolong the service life. Additionally, the sealing rings can also apply lubricant supplied by the oil pump to the inner wall of the cylinder evenly on the inner wall, so that friction between the cylinder wall and the rotary piston is reduced and lubrication is achieved. With effective reduction of the friction factor between the piston and the cylinder wall, working performance of the engine can be promoted, fuel consumption can be reduced, and the service life of the piston can be prolonged.

According to some embodiments, the engine comprises a base, wherein the cylinder is fixed above the base. According to these embodiments, the base is of strong utility, mainly designed to fix the bottom of the engine, so as to ensure normal, safe and reliable use of the engine.

The present disclosure provides a rotary engine featuring high efficiency, environmental friendliness and energy-saving operation. It offers a solution to a technical bottleneck of Mazda. It realizes low fuel consumption, low pollution, low emission, low temperature, low noise, and other technical advantages. It effectively enhances the wear resistance of the piston, and reduces the friction factor between the piston and the cylinder wall. In addition, it also promotes the working performance of the engine, while reducing fuel consumption and prolonging the service life of the piston. In addition to reducing exhaust emission of the engine, it is also energy-saving and environment-friendly. It can bring great economic benefits to users and manufacturers.

According to some embodiments, a piston engine comprises a shell, a crankshaft in the shell, and two sets of rotary pistons, wherein the crankshaft comprises two ends and the two sets of rotary pistons are positioned symmetrically at the two ends of the crankshaft and separated by a holder. Such a structure is more stable and an improvement over the existing single-rotary-piston structure.

According to some embodiments, a cylinder is configured to comprise two sets of rotary pistons that form a symmetrical dumbbell structure, thereby realizing mutual conversion of potential energy, i.e., when one rotary piston is working with the maximum load, the other rotary piston will release the potential energy stored to reduce the load on the working rotary piston. In such a way, the two sets of rotary pistons can realize mutual potential energy compensation during work as a twin structure, so as to render sound dynamic balance and stable operation. Additionally, the symmetrically positioned cylinders can effectively reduce noise and vibration during operation of the engine, and prolong the service life of the engine. Reduction of noise during engine operation has strong utility.

According to some preferred embodiments, the holder and the shell form an integrated structure, which is more stable than a structure in which the holder and the shell are separate.

According to some embodiments, a rotary piston comprises a combustion chamber having an oval vertical cross-section and two lateral sides, a crankshaft and a piston body in the combustion chamber, wherein the upper part of one side of the combustion chamber comprises an air inlet, the lower part of the same side of the combustion chamber comprises an air outlet, and the middle part of the other side of the combustion chamber comprises an embedded spark plug. According to some embodiments, the body of the piston engages with the crankshaft via an inner gear. According to some embodiments, the piston body has a cross-section with 360-degree arc edges and three 120-degree end faces, similar to three round plates crooking in the same direction. Each round plate forms a protruded end with a large head and a small tail. According to some embodiments, the head is a concaved arc head. According to some embodiments, overall the tail is concave toward the head, and the head is concave toward the tail. According to some embodiments, arc stress-bearing surfaces are formed between two sides of the protruded ends and the vertex angles of the piston body, wherein the area of the stress-bearing surfaces on the rotation side is greater than that on the other side. The ignition direction in the combustion chamber is perpendicular to a groove of the head. Shock waves of explosion directly thrust towards the groove. The groove is subject to a single-direction force, like a fishing boat sail, so that recoil of explosion is avoided and the impacting energy is converted to kinetic energy by almost one hundred percent. In the small combustion space at the tail is an arc stress-bearing surface inclining to the head, to ensure that residual recoiled gaseous fuel at the head can go back to the combustion chamber, other than leak backwards. The big-head and small-tail structure allows for thrust along the head to drive rotation and full combustion in the combustion chamber via multiple rotations, thereby realizing reduction of CO₂ emission.

According to some embodiments, the protruded end comprises a sealing ring embedded in the middle, which can enhance the sealing effect and realize smoother operation.

According to some embodiments, an engine device comprises a crankshaft connected to a power output shaft via a planetary gear, wherein a flywheel power compensation device is fixed on the power output shaft. According to these embodiments, the belt wheel transmission structure in existing engine devices has been improved to become an overall integrated structure that produces low noise. The integrated structure also has improved overall appearance by using no belt, while eliminating howling of the belt upon slipping due to rotating fatigue that causes failure of the reaction turbine and fan, high temperature of the automobile engine and grinding of crankshaft bushing. The engine device of the present disclosure saves power and can perform work requiring large power at a relatively slow rotating speed of the engine, while producing low noise, saving working time, reducing working loss and prolonging the service life of the engine. According to some embodiments, a circular flywheel power compensation device with high intensity and specific weight is added based on the existing gearwheel disk. When the engine rotates during normal operation, the flywheel power compensation device can generate a potential inertia of rotation. When the rotary piston of the automobile engine works at the upper dead point, the rotary piston bears the maximum load; at this time, the flywheel power compensation device can release the stored potential energy to overcome the load peak when the rotary piston works at the upper dead point. Besides, as the flywheel power compensation device has a larger diameter than the rotary engine piston, the potential energy produced by the flywheel power compensation device is greater than the maximum working load of the rotary piston. Therefore, the flywheel power compensation device can effectively provide energy for operation of the rotor, so that operation becomes simpler, while time and labor are saved.

According to some embodiments, the engine comprises a cooling system connected to an end far away from the flywheel power compensation device. The cooling system comprises a water cooler. The water cooler drives circulation of cooling water via a water pump connected to one side of the water cooler. The water pump is driven by the crankshaft and a transmission gear. The water cooler comprises a cooling fan fixed on the other side of the water cooler. According to these embodiments, the crankshaft moves to drive the water pump. The water pump drives circulation of cooling water. The cooling fan on the other side of the water cooler works to enhance the cooling effect. The oil pump and fan are free from wear during use, so that normal and stable operation of the fan and oil pump can be ensured.

Piston engines and engine devices of the present disclosure have several advantages. The symmetrically positioned rotary pistons can effectively reduce vibration of the engine, greater volume of combustion space along the direction of rotation allows for full combustion, and the mechanical lever structure plus an effective sealing device can resolve such technical bottlenecks as high temperature, loud noise and excessive emission of the engine.

### BRIEF DESCRIPTION OF THE DRAWINGS

FIG. 1 is a structural diagram illustrating an example of a rotary piston according to various embodiments.

FIG. 2 is a reference diagram illustrating an example of the working status of a rotary piston according to various embodiments.

FIG. 3 is a reference diagram illustrating another example of the working status of a rotary piston according to various embodiments.

FIG. 4 is a reference diagram illustrating yet another example of the working status of a rotary piston according to various embodiments.

FIG. 5 is a structural diagram of an engine device according to various embodiments.

### DETAILED DESCRIPTION

In the following description of embodiments, reference is made to the accompanying drawings which form a part hereof, and in which it is shown by way of illustrating specific embodiments of the disclosure that can be practiced. It is to be understood that other embodiments can be used and structural changes can be made without departing from the scope of the disclosed embodiments.

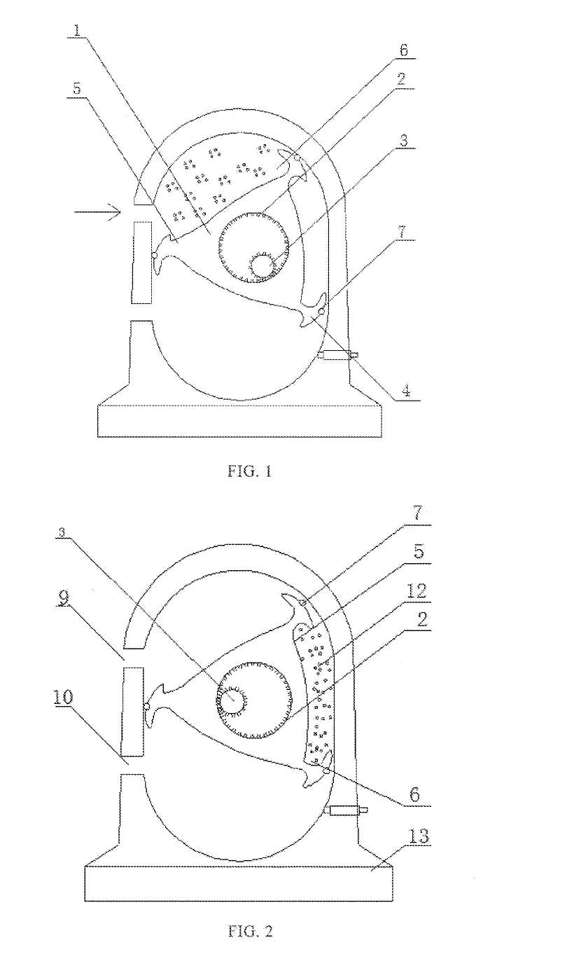

According to some embodiments of the present disclosure, and referring to FIGS. 1-4, a rotary piston comprises a piston body 1 having a triangular vertical cross-section, mutually engaged large and small planetary gears 2 fixed at the middle of the piston body 1, and a crankshaft 3 running through the small planetary gear. The piston body 1 features three angles on its vertical cross-section, each extending outwards to form a protruded end 4, with a 120-degree gap between adjacent protruded ends. Each protruded end 4 comprises a compression groove 5 formed at one side of the protruded end and a combustion groove 6 formed at the other side of the protruded end.

According to some embodiments, the combustion grooves are deeper than the compression grooves.

According to some embodiments, a protruded end comprises a sealing ring 7 embedded in the middle of the surface of the protruded end.

According to some preferred embodiments, the protruded ends have arc surfaces.

In the technical solution described above, the piston body engages with the crankshaft via the large and the small planetary gears; the piston body has a vertical cross-section with 360-degree arc edges, comprising three 120-degree end faces, similar to three round plates crooking in the same direction. Each round plate forms a protruded end with a large head and a small tail; both the head and the tail form concaved arcs; overall the tail arc is concave toward the head, and the head arc is concave toward the tail; between the head and the tail of the protruded ends and the vertex angles of the piston body are arc stress-bearing surfaces, wherein the area of the stress-bearing surfaces on the rotation side is greater than that on the other side. When the rotary piston is operating in a cylinder, a combustion chamber can be formed between the rotary piston and the inner wall of the cylinder. The ignition direction in the combustion chamber is perpendicular to groove of the head. Shock waves of explosion directly thrust towards the groove; the groove is subject to a single-direction force, like a fishing boat sail, so that recoil of explosion is avoided; and the impacting energy is converted to kinetic energy by almost one hundred percent. In the small combustion space at the end is an arc stress-bearing surface inclining to the head, to ensure recoiled gaseous fuel at the head can go back to the combustion chamber, other than leak backwards. The big-head and small-tail structure allows for thrust along the head end to drive the rotation and realize full combustion in the combustion chamber via multiple rotations, thus realizing reduced CO₂ emission.

According to some embodiments of the present disclosure, and referring to FIGS. 1-4, in order to solve the defects in the existing technology, the present disclosure discloses an engine applying the rotary piston described above and comprising the rotary piston and a cylinder 8, an air inlet 9 and an air outlet 10 on one side of the cylinder 8, and a spark plug 11 fixed on the other side of the cylinder 8, wherein the rotary piston is placed inside the cylinder, and fuel 12 can be filled in an empty chamber between the rotary piston and the inner wall of the cylinder.

According to some embodiments, clearances are left between the protruded end surfaces and the inner wall of the cylinder, with sealing rings contacting the inner wall of the cylinder.

According to some embodiments, the engine comprises a base 13, wherein the cylinder is fixed above the base.

According to these embodiments, the cylinder has an oval vertical cross-section and two lateral sides each having an upper part, a middle part and a lower part; at the upper part on one side of the cylinder is an air inlet, and at the lower part is an air outlet; at the middle part on the other side of the cylinder is an embedded spark plug.

The present disclosure describes a piston engine comprising a cylinder, a crankshaft and a piston body in the cylinder; the cylinder has an oval vertical cross-section and two lateral sides, each having an upper part, a middle part and a lower part; one side of the cylinder comprises an air inlet at the upper part, and an air outlet at the lower part; the other side of the cylinder comprises a spark plug embedded in the middle part; the piston body engages with the crankshaft via an inner gear; the piston body comprises a triangular vertical cross-section with arc edges; the end of each of the three angles of the piston body extends sideways, forming protruded ends; between the two sides of the protruded ends and the vertex angles of the piston body are arc stress-bearing surfaces, wherein the area of the stress-bearing surfaces on the rotation side is greater than that on the other side. Compared to existing rotary engines, through the protruded ends and the arc stress-bearing surfaces they form, a bigger combustion chamber is formed in the direction of rotation. This has two advantages. First, the arc surface brings fuel to rotate during operation, so that the fuel can be subject to secondary or even repeated combustion, in realization of full combustion and less pollutant in the exhaust. As a result, the combustion efficiency is higher and pollution is reduced. Second, in terms of stress bearing, with greater space and area to bear stress in the rotating direction, the engine described in the present disclosure has obvious better transmission than current rotary engines. The engine has the explosive force at an oriented angle in a straight line with the rotating angle of the rotary piston upon ignition of the engine, so that recoil and cylinder-knocking noise produced by rectangular impact from combustion explosion in an engine (such as that manufactured by Mazda) are eliminated; meanwhile, the explosive force drives the rotor clockwise to work, so that explosive impact in all directions on the two sides of the rotor is avoided, while fuel to be combusted is retained and high temperature is maintained. In such a way, the present disclosure has provided a solution to the current technical bottlenecks, such as high engine temperature, loud noise and excessive emission.

The present disclosure adopts the mechanical principles of lever mechanics, wherein the leverage moment is automatically adjusted based on the force required upon ignition and operation of the engine, to realize maximum moment upon working of the rotary piston of the engine, minimum duty upon suction of fuel for operation, and ½ moment is saved upon compression of fuel. The present disclosure also discloses a rotary piston and an engine comprising the rotary piston that integrates directed explosion and shock waves, thermodynamic vertex combustion and kinetic combustion in the combustion chamber of the rotary piston. The highly efficient, environment-friendly and energy-saving rotary engine piston has the explosive force at an oriented angle in a straight line with the rotating angle of the rotary piston upon ignition of the engine, so that recoil and cylinder-knocking noise produced by rectangular impact from combustion explosion in an engine such as one manufactured by Mazda are eliminated; meanwhile, the explosive force drives the rotor clockwise to work, so that explosive impact in all directions on the two sides of the rotor is avoided, while fuel to be combusted is retained and high temperature is maintained. In such a way, the present disclosure has solved such technical bottlenecks as high engine temperature, loud noise and excessive emission. Additionally, the engine is convenient for use and simple for operation; it realizes low fuel consumption, low pollution, low emission, low temperature, and low noise; it effectively enhances the wear resistance of the piston, and reduces the friction factor between the piston and the cylinder wall. In addition, it also promotes the working performance of the engine, while reducing fuel consumption and prolonging the service life of the piston. In addition to reducing exhaust emission of the engine, it is also energy-saving and environment-friendly.

In actual use, the rotary piston and the engine comprising the rotary piston described in the present disclosure can bring the following economic benefits:

(1) For a manufacturing enterprise that manufactures 5 million engines a year, traditional engine technology requires the consumption of 5 billion tons of steel; based on the price of RMB 3,750 per ton, RMB 18.750 trillion is needed.

(2) For a manufacturing enterprise that manufactures 5 million rotary engines a year, if 80% steel is saved of each engine, 4 billion tons of steel will be saved out of 5 billion tons; only 1 billion tons of steel is required to satisfy the need of production; and RMB15 trillion can be saved.

(3) If production of one ton of steel requires 1000 KWh of electricity, then production of 5 billion tons requires 5 trillion KWh of electricity; if one KWh of electricity costs RMB 0.58, RMB 2900 billion can be saved.

(4) If one KWh of electricity generates around 0.96 kg carbon emission, then 5 trillion KWh will generate 4.8 trillion kg carbon emission. Compared with the engines provided by the current technology, the engine described in the present disclosure can reduce carbon emission, and is a solution to the problem of PM 2.5 pollution, bringing invaluable social and economic benefits to the country's energy saving and emission reduction.

(5) If each vehicle with a rotary engine travels 30,000 km a year, then each vehicle will travel 300,000 km in ten years; if 10 liters gasoline is consumed for each 100 km travel and 30% gasoline can otherwise be saved, then 3 liters will be saved per each 100 km, 0.03 liters saved per each km, and 9,000 liters saved for 300,000 km. If one liter of gasoline costs RMB 8, then for one vehicle RMB 72,000 can be saved in ten years, and for 5 million vehicles RMB 360 billion can be saved.

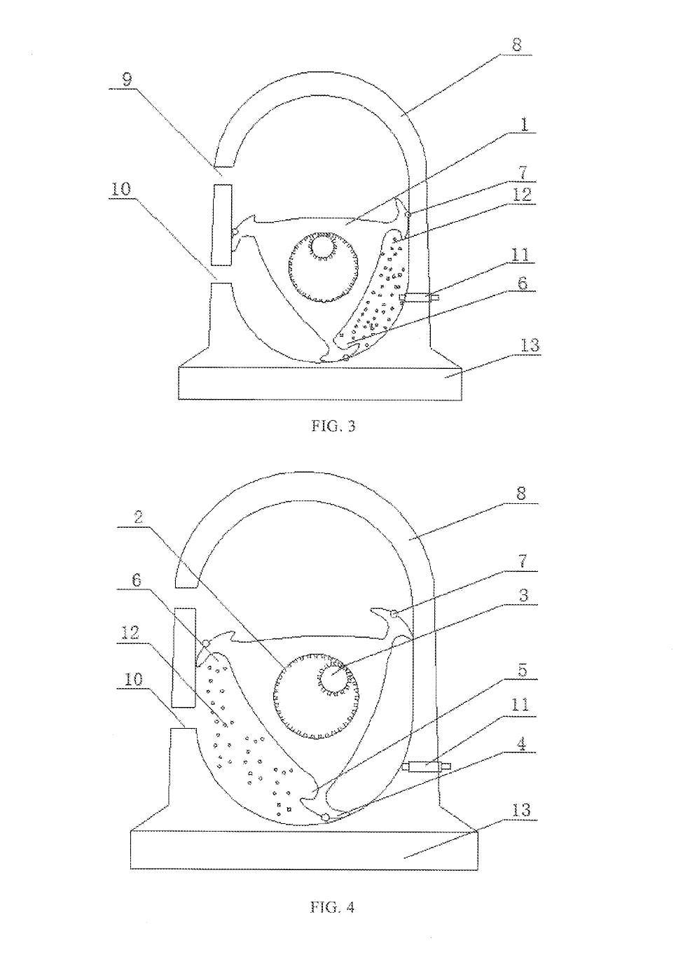

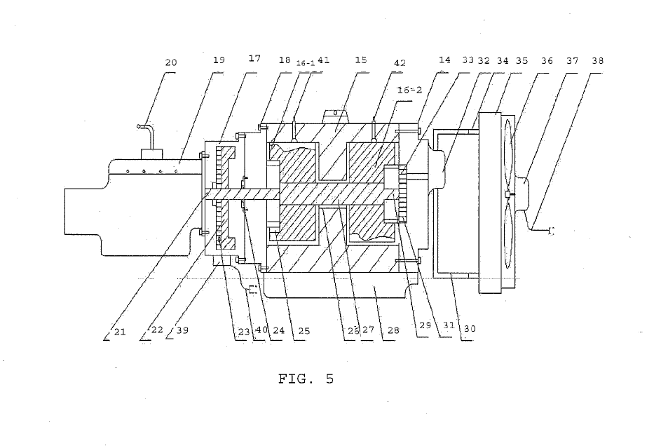

FIG. 1 is a structural diagram illustrating an example of a rotary piston according to various embodiments, and illustrates the air suction when the engine is in use. FIGS. 2 and 3 are reference diagrams illustrating examples of the working status of a rotary piston according to various embodiments, and illustrate the ignition and heating when the engine is in use, accompanied by compression. FIG. 4 is a reference diagram illustrating another example of the working status of a rotary piston according to various embodiments, and illustrates the exhaustion when the engine is in use. As described in the foregoing technical solution and shown in FIGS. 1-4, the rotary piston provided in the present disclosure are a completely new creative concept, as well as a green hi-tech product for replacing the current reciprocating engine and rotary engine. As indicated in the description above, the product brings great economic benefits, and the technical solution effectively enhances the wear resistance of the piston, and reduces the friction factor between the piston and the cylinder wall; besides, it also promotes the working performance of the engine, while reducing fuel consumption and prolonging the service life of the piston. In addition to reducing exhaust emission of the engine, it is also energy-saving and environment-friendly.

According to some embodiments of the present disclosure, and referring to FIG. 5, a piston engine comprises a shell 14, a crankshaft 27 in the shell 14, and two sets of rotary pistons 16-1 and 16-2, wherein the crankshaft comprises two ends and the two sets of rotary pistons 16-1 and 16-2 are positioned symmetrically at the two ends of the crankshaft 27 and are separated by a holder 15. One end of the crankshaft 27 is connected to a power output shaft 21, while the other end is connected to an engine oil system and a cooling water system, in each case via a gear transmission structure. In FIGS. 5, 16-1 and 16-2 are the two rotary pistons 16 symmetrically positioned next to the holder 15; due to the symmetry, opposite kinetic energy of the rotary pistons during movement can be offset, so that vibration of the engine can be reduced. The holder and the shell form an integrated stable structure, which is more effective.

Each of the rotary pistons in these embodiments operates within a cylinder and the rotary piston and the cylinder together form a structure that is the same as the structure of the piston engine described above. According to these embodiments, the structure comprises a cylinder having an oval vertical cross-section and two lateral sides, each having an upper part, a middle part and a lower part, and a crankshaft and a piston body in the cylinder. One side of the cylinder can comprise an air inlet at the upper part, and an air outlet at the lower part. The other side of the cylinder can comprise a spark plug embedded in the middle part. The piston body can engage with the crankshaft via an inner gear. The piston body can have a triangular cross-section with arc edges. The tip of each of the three angles of the piston body can extend sideways, forming two protruded ends; arc stress-bearing surfaces are formed between two sides of the protruded ends and the vertex angles of the piston body, wherein the area of the stress-bearing surfaces on the rotation side is greater than that on the other side.

Furthermore, a protruded end can comprise a sealing ring embedded in the middle of the end surface of the protruded end.

According to some embodiments, an engine of the present disclosure can have a dumbbell structure with two pistons. The structure is to facilitate kinetic balance and potential energy complementation between the two rotors of the engine. The two pistons can be connected by a fixed shaft, and symmetrically positioned at the two sides of the central shaft for weight balance. The two pistons can work at −180 degrees and +180 degrees respectively to realize complementation during their respective operation. The output power and stability of the dumbbell double-rotor structure are equivalent to those of existing six-cylinder engines, while consuming only one third of the amount of fuel and reducing the emission by 60%.

According to some embodiments and referring to FIG. 5, an engine device comprises a crankshaft connected to a power output shaft via a planetary gear, wherein a flywheel power compensation device is fixed on the power output shaft. One end of the crankshaft 27 can fix the flywheel power compensation device 22 via the planetary gear 25. A preferred embodiment of the flywheel power compensation device 22 is the power compensation device provided in Chinese Patent Application No. 92208890.X. The power compensation device makes it possible that an engine of the present disclosure with half power can fulfill work that is fulfilled by an engine currently used in the industry with full power. Meanwhile, the idle revolutions of the engine can be reduced by ½ to around 400 rounds, and ½ fuel can be saved upon idling.

According to some embodiments, the engine can comprise a cooling system connected to an end far away from the flywheel power compensation device. The cooling system can include a water cooler. The water cooler can drive circulation of cooling water via a water pump connected to one side of the water cooler. The water pump can be driven by the crankshaft and a transmission gear. The water cooler can comprise a cooling fan fixed on the other side of the water cooler. The crankshaft 27 can drive two devices, i.e. a cooling device and a lubricating device, via its front shaft end 29 at the end far away from the flywheel power compensation device 22. The cooling device can comprise a water pump 32, a cooler and a cooling fan. The cooler can realize circulation of cooling water via the water pump 32. The water pump 32 can be connected to a gear transmission of the front shaft end 29 via an oil pump gear, and thus can be directly driven by the crankshaft 27 of the engine, so that simultaneous operation of the cooling device with operation of the engine can occur. Cooling systems currently used in the industry are driven by complex belt wheels. The disclosure has simplified the structure, thus making both manufacturing and use easier. The lubricating device can comprise an oil sump at the bottom of the shell 14 and an oil pump gear engaged with the gear of the front shaft end 29, which is the same as used in existing technology.

Except for the features described above, the rotary engine of the present disclosure is the same as the rotary engines in the existing technology.

The present disclosure provides a piston engine and an engine device comprising the piston engine. Under same power conditions, the piston engine of the present disclosure features a simpler structure, 60% reduction of parts, one third the size and ⅕ the weight of existing piston engines. Meanwhile, it has no exposed belt to connect the water pump 32 to the cooling fan 36, and has a fully built-in engine cooling system. The piston engine of the present disclosure has the advantages of fewer parts, simple technological procedures and easy manufacturing; it also saves labor and resources, while reducing pollution to the production environment.

Numbered items in FIGS. 1-5 have the following meanings:

1. Piston body; 2. Planetary gear; 3. Crankshaft; 4. Protruded end; 5. Compression groove; 6. Combustion groove; 7. Sealing ring; 8. Cylinder; 9. Air inlet; 10. Air outlet; 11. Spark plug; 12. Fuel; 13. Base; 14. Shell; 15. Holder; 16. Rotary piston; 17. Connecting plate; 18. Fixing bolt; 19. Gearbox; 20. Transmission lever; 21. Power output shaft; 22. Flywheel power compensation device; 23. Flywheel gear; 24. Clutch; 25. Planetary gear; 26. Shaft bushing; 27. Crankshaft; 28. Oil sump; 29. Front shaft end; 30. Water inlet; 31. Oil pump gear; 32. Water pump; 33. Water pump gear; 34. Out-going pipe; 35. Water cooler; 36. Cooling fan; 37. Fan motor; 38. Power supply to fan motor; 39. Starter; 40. Starter power; 41. Spark plug; 42. Combustion chamber.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A rotary piston, comprising
a piston body having a triangular vertical cross-section,
mutually engaged large and small planetary gears fixed at the middle of the piston body, and
a crankshaft running through the small planetary gear,
wherein the three angles of the triangular cross-section extend outwards to form protruded ends with a 120-degree angle between adjacent protruded ends, and the two sides of each protruded end form a compression groove and a combustion groove, respectively.

2. The rotary piston of claim 1, wherein the combustion groove is deeper than the compression groove.

3. The rotary piston of claim 1, wherein each protruded end comprises a sealing ring embedded in the middle of the surface of the protruded end.

4. The rotary piston of claim 1, wherein each protruded end has an arc surface.

5. An engine comprising
the rotary piston of claim 1, and
a cylinder having two lateral sides, wherein
one side of the cylinder comprises an air inlet and an air outlet, and the other side of the cylinder comprises an embedded spark plug,
the rotary piston is placed inside the cylinder, and
fuel is fillable in an empty chamber between the rotary piston and an inner surface of the cylinder.

6. The engine of claim 5, further comprising a base, wherein the cylinder is fixed above the base.

7. An engine comprising
the rotary piston of claim 3, and
a cylinder having two lateral sides, wherein
one side of the cylinder comprises an air inlet and an air outlet, and the other side of the cylinder comprises an embedded spark plug,
the rotary piston is placed inside the cylinder, and
fuel is fillable in an empty chamber between the rotary piston and an inner surface of the cylinder.

8. The engine of claim 7, wherein clearances are left between the surface of the protruded ends and the inner surface of the cylinder, and the sealing rings contact the inner surface of the cylinder.

9. The engine of claim 7, further comprising a base, wherein the cylinder is fixed above the base.

10. A piston engine comprising a shell, a crankshaft in the shell, and two sets of rotary pistons, wherein the crankshaft has two ends and the two sets of rotary pistons are positioned symmetrically at the two ends of the crankshaft and separated by a holder.

11. The piston engine of claim 10, wherein the two sets of rotary pistons form a symmetrical dumbbell structure.

12. The piston engine of claim 10, wherein the holder and the shell form an integrated structure.

13. The piston engine of claim 10, wherein each set comprises a cylinder having two lateral sides and enclosing the crankshaft and a piston body, wherein one side of the cylinder comprises an air inlet and an air outlet, and the other side of the cylinder comprises an embedded spark plug.

14. The piston engine of claim 13, wherein the piston body engages with the crankshaft via an inner gear.

15. The piston engine of claim 13, wherein the piston body has a triangular vertical cross-section with arc edges, and the three angles of the piston body extend sideways at the tip of the angles, forming protruded ends.

16. The piston engine of claim 15, wherein arc stress-bearing surfaces are formed between two sides of the protruded ends and the vertex of the angles of the piston body, and the area of the stress-bearing surfaces on the rotation side is greater than that on the other side.

17. The piston engine of claim 15, wherein a sealing ring is embedded in the middle of each protruded end.

18. An engine device comprising the piston engine of claim 10, wherein the crankshaft is connected to a power output shaft via a planetary gear, and a flywheel power compensation device is fixed on the power output shaft.

19. The engine device of claim 18, wherein the piston engine comprises a cooling system connected to an end far away from the flywheel power compensation device.

20. The engine device of claim 19, wherein the cooling system comprises a water cooler that drives circulation of cooling water via a water pump connected to one side of the water cooler, the water pump is driven by the crankshaft and a transmission gear, and a cooling fan is fixed on the other side of the water cooler.
